(19) United States
(12) Patent Application Publication
(10) Pub. No.: US 2004/0140292 A1
(43) Pub. Date: Jul. 22, 2004

(54) Micro-welded gun barrel coatings

(76) Inventors: John E. Kelley, Gaston, OR (US); Clayton J. Lindsay, Portland, OR (US); Michael A. Riley, (US)

Correspondence Address: Glenn C. Brown, P.C., Suite 308, 777 N.W. Wall Street, Bend, OR, 97701, US

(21) Appl. No.: 10/689,879

(22) Filed: Oct. 21, 2003

Related U.S. Application Data
(60) Provisional application No. 60/420,061, filed on Oct. 21, 2002.

(51) Int. Cl. B23K 28/00

(52) U.S. Cl. 219/76.13

(57) ABSTRACT

A micro-welding process is used to apply erosion and wear resistant coatings to the internal diameter of gun barrels. The applied coatings are then treated by methods such as honing and/or rotary forging. The protective micro-welded coatings may comprise ceramic, cermet and/or refractory metal materials, and may be used with rifled or smooth gun barrels of various sizes.

### CROSS-REFERENCE TO RELATED APPLICATION

This application claims the benefit of U.S. Provisional Patent Application Serial No. 60/420,061 filed Oct. 21, 2002, which is incorporated herein by reference.

### GOVERNMENT CONTRACT

The United States Government has certain rights to this invention pursuant to Contract No. M67854-01-C-1043 awarded by the United States Marine Corps.

### FIELD OF THE INVENTION

This invention relates to gun barrels with internal diameters having micro-welded protective coatings which provide improved temperature and wear/erosion resistance. This invention also relates to a process for the application of micro-welded coatings to the internal diameters of gun barrels.

### BACKGROUND INFORMATION

Gun barrels operate under very extreme conditions, including pulsed high temperature environments in combination with corrosive gases and erosive particulates. For many years, most gun barrels have been protected by a thin coating of hard chrome, deposited through a plating process that utilizes hexavalent chrome, a known carcinogen and a toxic and hazardous material. It is highly desirable from the gun manufacturing community to reduce their dependence on the use of hexavalent chrome as a coating agent. Moreover, government regulations are restricting the use of this coating agent.

In addition to environmental issues, hexavalent chrome plate has many drawbacks as a gun barrel coating material. In its as plated condition, hard chrome adheres to the gun barrel through mechanical means only, and has no chemical bonding to the gun barrel base metal. Furthermore, most hard chrome surfaces are riddled with surface cracks that proceed down to the gun barrel material interface. As hot gases are generated in the firing of the weapon, these cracks act as paths for both high temperatures and corrosive propellant gases and particulates. The result is the random flaking and erosion of the chrome plate as the gun is fired. Further, during the plating process, the chrome metal is often plated in a non-uniform manner, leaving variations in thickness across the gun barrel and leading to the pre-mature failure of the barrel to accurately deliver bullets and munitions to their intended target.

The present invention has been developed in view of the foregoing.

### SUMMARY OF THE INVENTION

The present invention provides an improved method for the deposition of protective coatings directly to the inner wall of a gun barrel, including smooth-bored and rifled barrel designs. The coated surfaces are produced by micro-welding techniques, such as electro-spark deposition, pulse-fusion and the like. The deposited coatings are then surface treated by working methods such as forging and/or honing to provide the desired surface finish.

Unlike conventional chrome-plating technology, the present micro-welding process is capable of fusing the coating to the inner wall of the gun barrel. Instead of being limited to hard chrome, the invention offers the ability to form a wide range of metallurgically bound ceramic, cermet and refractory metal coatings on gun barrel inside diameters. Furthermore, the micro-welding process enables the formation of coatings that are nano-grained in structure, which offers additional strength and wear/erosion resistance.

An aspect of the invention is to provide a surface on the inside diameter of a gun barrel which imparts longer barrel life through improved wear/erosion resistance and thermal management of the barrel as it is fired. This is accomplished through the formation of protective coatings comprising ceramics, cermets and/or refractory alloys that are resistant to wear, erosion and high temperature oxidation. The composition and purity of the ceramic, cermet or refractory alloy can be controlled or augmented by performing the micro-welding process in open air, inert or active cover gas, a liquid medium or full or partial vacuum. In addition to the compositional benefits of the coatings, additional protection is imparted through the formation of these coatings as a nano-grained structure, which may impart superior mechanical properties in comparison with materials of an equivalent chemistry but with a larger grain size.

Another aspect of the invention is to reduce friction in the gun barrel through the deposition of lubricating materials such as micro-welded molybdenum or other lubricious refractory metals.

A further aspect of the invention is to provide coatings to rifled barrels through direct micro-welding of the coating to the pre-rifled barrel, or through the coating of a smooth barrel blank, followed by rifling in such a manner that most or all of the micro-welded coating is maintained during the rifling process. Additional processing, such as honing, may be performed after the rifling process.

Another aspect of the invention is to form micro-welded coatings on gun barrels of various diameters, e.g., ranging from 5.56 mm to 150 mm, and various lengths, e.g., ranging from about 2 inches to over 30 feet. To accomplish this with the precision demanded in a gun barrel, the micro-welding steps can be accomplished via the control of the welding head through any variety of multi-axis tools such as multi-axis robots, X-Y-Z tables, lathes, milling machines and other machine tools.

A further aspect of the present invention is to provide a method of coating an interior surface of a gun barrel comprising micro-welding a protective coating on the interior surface of the gun barrel, and working the micro-welded coating.

Another aspect of the present invention is to provide a gun barrel comprising an interior surface and a micro-welded protective coating on the interior surface.

These and other aspects of the present invention will be more apparent from the following description.

### BRIEF DESCRIPTION OF THE DRAWINGS

FIG. 1 is a partially schematic illustration of a gun barrel micro-welding process utilizing a rotating barrel and a micro-welding electrode in accordance with an embodiment of the present invention.

FIG. 2 is a longitudinal section view of the gun barrel and micro-welding electrode shown in FIG. 1.

FIG. 3 is a photomicrograph of a cross section of a steel gun barrel with a Tribolite micro-welded coating in accordance with an embodiment of the present invention.

FIG. 4 is a photomicrograph of a cross section of a steel gun barrel with a 7473 carbide micro-welded coating in accordance with an embodiment of the present invention.

FIG. 5 is a photomicrograph of a cross section of a rifled gun barrel after micro-welding deposition of a coating, rotary forging and extrude-honing in accordance with an embodiment of the present invention.

FIGS. 6a and 6b are photomicrographs of a rifled gun barrel with a Tribolite micro-welded coating at the breech and muzzle ends of the barrel, respectively.

FIGS. 7a and 7b are photomicrographs of a rifled gun barrel with a molybdenum-rhenium micro-welded coating at the breech and muzzle ends of the barrel, respectively.

FIGS. 8a and 8b are photomicrographs of a rifled gun barrel with a molybdenum-titanium-zirconium micro-welded coating at the breech and muzzle ends of the barrel, respectively.

### DETAILED DESCRIPTION

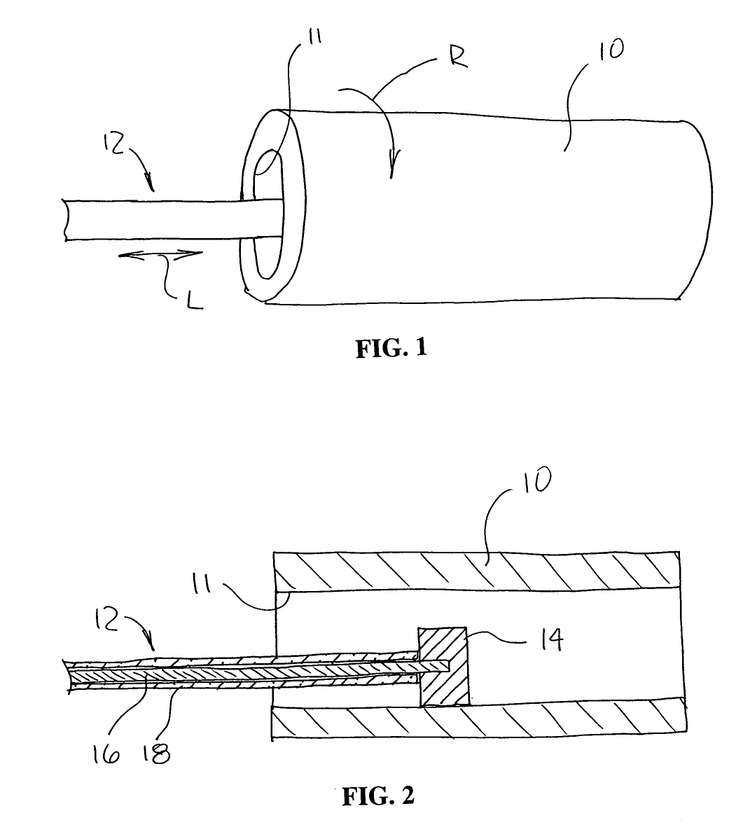

FIG. 1 schematically illustrates a gun barrel micro-welding process in accordance with an embodiment of the present invention. A gun barrel 10 having an inner diameter 11 is rotated in a direction R around a longitudinal axis of the gun barrel 10. The gun barrel 10 may be made of any suitable material, such as steel, titanium or other metal, having any desired dimensions. A micro-welding electrode assembly 12 is inserted in the gun barrel 10, and is longitudinally movable in a direction L inside the gun barrel 10.

FIG. 2 is a longitudinal section view of the gun barrel 10 and electrode assembly 12 arrangement of FIG. 1. The micro-welding electrode 12 includes a tip comprising an electrode material 14 which is generally disk-shaped. An electrically conductive rod 16 is secured in a hole in the electrode material 14. An insulating tube 18 surrounds the electrically conductive rod 16.

In the embodiment shown in FIGS. 1 and 2, during the micro-welding process, the gun barrel 10 is rotated R and the micro-welding electrode assembly 12 is moved longitudinally L within the gun barrel 10 in order to micro-weld the electrode material 14 to the inner surface 11 of the gun barrel 10, as more fully described below. Alternatively, the electrode assembly 12 may be rotated, in which case the gun barrel 10 may be held stationary or may also be rotated. Furthermore, the electrode assembly 12 may be held in a stationary position while the gun barrel 10 is moved in the longitudinal direction L. Although a generally disk-shaped electrode material 14 is shown in FIG. 2, any other suitable electrode material shape or arrangement may be used in accordance with the present invention.

The micro-welded protective coating may have a thickness ranging from about 0.1 to about 10 mils, typically from about 0.5 to about 2 mils. The micro-welded coatings may include carbides, borides and nitrides of the transition metals, refractory alloys such as Stellite alloys, Colmonoy alloys, Tribolite alloys, TZM alloys including titanium and zirconium alloying additions, molybdenum-rhenium alloys, tungsten alloys and tantalum alloys. These materials may be used in combination with high temperature lubricating metals or alloys such as molybdenum or iridium. The individual alloys may comprise the entire length of the barrel, or specific alloys may be deposited along a portion of the barrel, with the remainder being coated by another alloy. For example, one-half of the barrel length may be coated with Stellite 21, and the other half of the barrel length may be coated with molybdenum/rhenium.

The barrel base metal can be comprised of steel, titanium, or other metal or alloy. The barrel length can range from about 2 inches to over 30 feet. The barrel may have any desired inside diameter, for example, the barrel inside diameter can range from 5.56 mm to 155 mm. The barrel can be for all calibers of handguns, semi-automatic weapons, automatic weapons, mortars, gatling guns, chain guns, long range barrels for tanks, light artillery, heavy artillery and the like.

In accordance with the present invention, the protective gun barrel coating is produced by micro-welding techniques, such as electro-spark deposition, pulse-fusion or other similar techniques. Some examples of deposition techniques which may be used to form micro-welded gun barrel coatings in accordance with the present invention are disclosed in U.S. Pat. Nos. 4,405,851, 4,551,603, 5,448,035 and 6,417,477, each of which is incorporated herein by reference.

The electro-spark deposition process generally includes the utilization of an electrode, through which short duration, high amperage charges are directed through the electrode and the gun barrel surface. Extremely short duration discharges at high frequencies result in deposition of the electrode material onto the internal surface of the gun barrel, such that it becomes micro-welded. The electrode may be rotated, oscillated and/or vibrated during the deposition process. The micro-welding process may be performed in any desired environment, for example, in open air, under a cover gas, under a submerged liquid or in a full or partial vacuum.

The following variables may be controlled at the welding electrode tip: electrode current and voltage; pulse width of the energy input; rotation of the welding electrode; oscillation of the welding electrode; cooling of the electrode; and chemistry of the electrode. In the process, a consumable electrode is brought into direct contact with the part being coated. An onboard computer may be used to control the deposition of the coating. The process provides a full metallurgical bond between the electrode coating and the substrate metal, substantially no heat affected zone in the base alloy, an amorphous to nano-grained structure in the coating, the ability to coat very small internal diameters, e.g., down to 0.2 inches or less, and the ability to coat non-line-of-sight areas. The process can be readily coupled to multi-axis tooling to become a highly reproducible manufacturing process.

Coatings are formed by the consumption of the material in the welding electrode. Electrodes are made, for example, either by sintering powders, by machining the electrode from solid materials (or cutting via wire EDM), or by a thermal spray method in which powders are blended to any composition desired, then sprayed using a thermal spray technology (plasma or HVOF) onto a metal substrate, permitting the coating to build up to the desired thickness, e.g., at least 6 millimeters. The coating can then be removed and formed into electrodes. These blends of powder materials can then form new alloys when arc discharged onto the gun barrel surface.

The electrode may be made in the form of a straight rod, a disk, or any other suitable shape that can be inserted into a gun barrel to permit inside diameter coating. This may be achieved with gun barrel inside dimensions of 0.2 inches or smaller. Flexible electrodes may optionally be employed to reach any areas that are non-line-of-sight. The electrodes may optionally be fitted with a flexible fiber-optic camera to verify the coating application.

The grain size of the final product can range from amorphous to nano-grained. Nano-grained materials may have average grain sizes up to about 100 nm, for example, from about 5 or 10 nm to about 50 nm. The grain size of the starting material in the electrode can be of any commercial low cost grain size available. By virtue of the pulse mode employed by the weld system, the ceramic and metal coatings can be formed without delivering any substantial heat into the base alloy of the barrel. For example, peak temperatures of 170° F. or less may be experienced when relatively thick layers are built up to tens of thousandths of an inch. Hardness testing through the coating layer down in to the base alloy reveals that the hardness of the base alloy remains substantially unchanged, even at a distance of only 3 microns away from the fully bound coating. The original properties of the base alloy materials are maintained.

The coated barrel may undergo a post-deposition working step, for example, rotary forging, in which the micro-welded coating is preserved as rifling is formed into the barrel. Alternatively, the coated barrel may be honed by standard honing techniques, including extrude-honing techniques, or by projectiles during use of the gun barrel. In one embodiment, the gun barrel is coated in a “barrel-blank” condition in which the barrel has a smooth surface prior to the formation of rifling by rotary forging, button swaging or other types of mechanical deformation processes that induce a rifled surface without machining. In this embodiment, the barrel is coated prior to the rifling process, and the resultant coating is smoother and may have more uniform density as a result of the forging/swaging process.

### EXAMPLES

Examples of micro-welding electrode materials include tantalum-tungsten carbide, tantalum-titanium carbide, titanium diboride, hafnium carbide, tantalum-10 tungsten, molybdenum-rhenium, tungsten, and the like. Some coating materials are shown in Table 1.

TABLE 1
Coating Materials

| | | | Hardness |
|---|---|---|---|
| Alloy | Properties | Composition | (25 kg load) |
| Tribolite | High hardness, | Boride/Mo/Si | 680 Knoop |
| | lubricity | | |
| Moly-Rhenium | High toughness | 52.5% Mo | 395 Knoop |
| | | 47.5% Re | |
| Molybdenum TZM | High toughness | 99.3% Mo | 520 Knoop |
| | | 0.55% Ti | |
| | | 1.2% Zr | |
| | | 0.04% C | |
| 7473 Carbide | High hardness, | WC/TaC/Co | 850 Knoop |
| | excellent wear | | |
| | resistance | | |
| 7422 Carbide | High hardness, | WC/TaC/TiC/Co | 630 Knoop |
| | excellent wear | | |
| | resistance | | |

Each of the listed coating materials may be formed into an electrode as a small diameter disk similar to the arrangement shown in FIGS. 1 and 2 capable of fitting into the barrel without touching the side walls. This disk has a center hole, and is mounted on a conductive metal rod that is protected with an insulating sleeve. This assembly is attached to an electro-spark alloying (ESA) torch and mounted on a lathe. The lathe permits the precise movement of the electrode from one end of the barrel blank to the other, while the barrel blank is rotated at a constant RPM. These combined motions may be optimized as necessary to achieve a uniform coating quality. Coating adhesion and coating uniformity may be optimized by controlling the voltage and current of the welding unit, as well as the pulse width and pulse frequency. The process may deposit, for example, 1.5 to 2.0 thousandths of an inch of ceramic/refractory coating on the base alloy of the gun barrel.

The micro-welded coatings may be evaluated using metallurgical analysis including optical microscopy, scanning electron microscopy, microhardness indentation studies and x-ray microanalysis. Desired properties of the deposited coatings include chemical uniformity, low-to-no heat affected zone in the base metal, high coating density and uniform thickness. A completely dense coating at this step in the process may not be necessary, as the subsequent working process, such as forging, may provide additional coating densification. The combination of the full metallurgical bond provided by the micro-welding process, together with the unique micro-grain size achieved by the process, permits plastic deformation without causing micro-cracking in the ceramic or refractory coating.

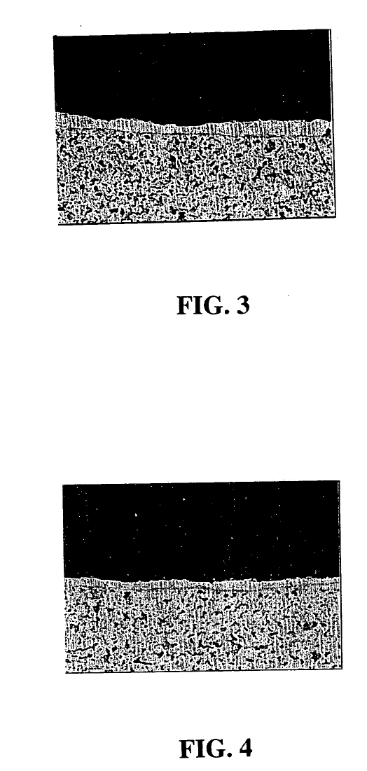

Barrel blanks coated with the materials may be subjected to microstructural examination prior to proceeding to forging steps. FIGS. 3 and 4 are micrographs of steel gun barrel cross sections with Tribolite and 7473 micro-welded coatings, respectively.

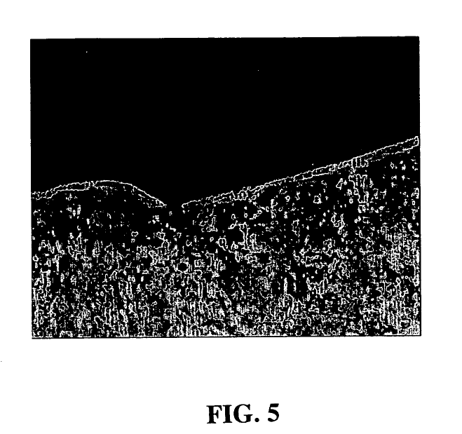

In a subsequent rotary forging process, the barrel blanks may essentially be extruded from a diameter of 7.87 mm down to a final 5.56 mm diameter. In this process, a solid carbide die is placed inside the barrel. This die has the rifling machined into it, and the rifling is then transferred to the barrel as the extrusion takes place. The forging mandrel is sized to produce a final rifled dimension on the coated blanks after forging. Tungsten carbide mandrels may be treated with a diamond coating to provide wear resistance during the rotary forging operation. The coated barrels may be subjected to destructive evaluation in order to verify the metallurgical bond, as well as other properties of the coatings. FIG. 5 is a micrograph of a gun barrel cross section after rotary forging and extrude-honing.

Rotary forging of coatings may be performed as follows: coatings are applied to 0.310 inch ID barrel blanks prior to forging; barrel blanks are then extrude-honed to smooth coatings; blanks are then forged to correct dimension using diamond coated mandrels. Inspection criteria include land diameter, groove diameter, twist, straightness and outside diameter. Table 2 lists test samples and post-processing inspection data generated on the coated barrels. All barrels pass the standard boroscope inspection (coverage), twist and straightness criteria.

TABLE 2

| Trial | | | | OD |
|---|---|---|---|---|
| # | Coating Material | Land Dia. (mm) | Groove | Dia. (mm) |
| 1 | Stellite 20 | 5.561-5.563 | 5.681-5.684 | 22.05 |
| 2 | Stellite 20 | 5.553-5.556 | 5.677-5.681 | 22.09 |
| 3 | Tribolite | 5.554-5.562 | 5.678-5.681 | 22.07 |
| 4 | Moly-Rhenium | 5.551-5.559 | 5.674-5.679 | 22.06 |
| 5 | Moly-TZM | 5.551-5.553 | 5.675-5.680 | 22.04 |
| 6 | 7422 Carbide | 5.558-5.561 | 5.681-5.686 | 22.04 |
| 7 | Tribolite | 5.555-5.560 | 5.683-5.690 | 22.05 |
| 8 | Tribolite | 5.553-5.556 | 5.682-5.684 | 22.04 |
| 9 | Tribolite | 5.554-5.558 | 5.684-5.685 | 22.05 |
| 10 | Tribolite | 5.554-5.560 | 5.683 | 22.05 |
| 11 | Moly-Rhenium | 5.549-5.553 | 5.678-5.681 | 22.06 |
| 12 | Moly-Rhenium | 5.552-5.554 | 5.678-5.682 | 22.06 |
| 13 | Moly-Rhenium | 5.551-5.554 | 5.677-5.680 | 22.04 |
| 14 | Moly-Rhenium | 5.551-5.552 | 5.677-5.680 | 22.04 |
| 15 | Moly-TZM | 5.548-5.551 | 5.676-5.680 | 22.05 |
| 16 | Moly-TZM | 5.546-5.551 | 5.677-5.680 | 22.06 |
| 17 | Moly-TZM | 5.549-5.555 | 5.677-5.680 | 22.06 |
| 18 | Moly-TZM | 5.552-5.553 | 5.677-5.680 | 22.03 |

Land diameter dimension: 5.550 ± .025 (mm)
Groove diameter dimension: 5.685 ± 0.20 (mm)
OD diameter dimension: 22.1 ± .1 (mm)

The barrels may undergo live-fire testing, e.g., two test barrels of each coating composition may be test fired to 2000 rounds. A ratio of 4 ball to 1 tracer may be used for test firing. The addition of tracer rounds is known to accelerate the wear seen in gun barrels. Barrels may be fired using a standardized firing protocol of 3 round bursts followed by 2-4 second pause. The barrels may be switched out every 200 rounds. The receiver may be cleaned and serviced every 4000 rounds according to maintenance manuals.

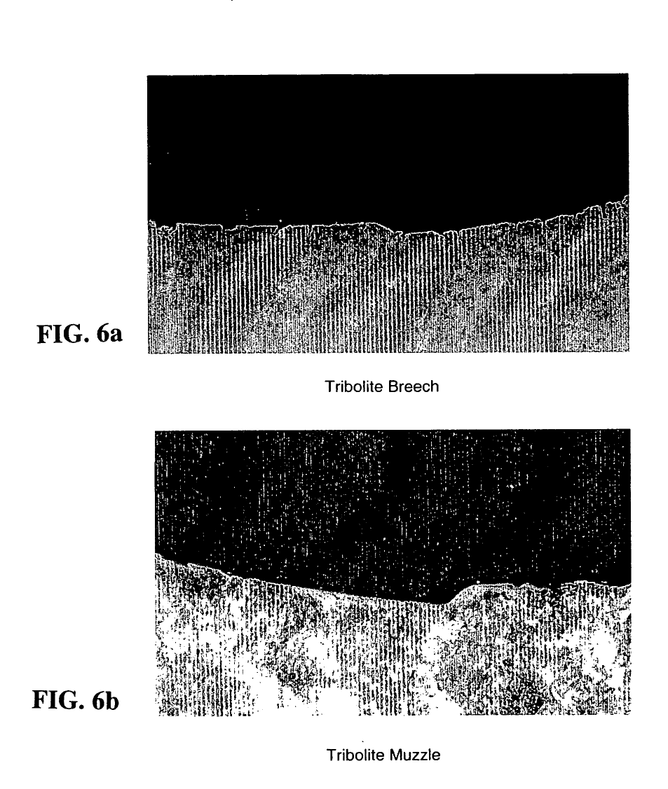

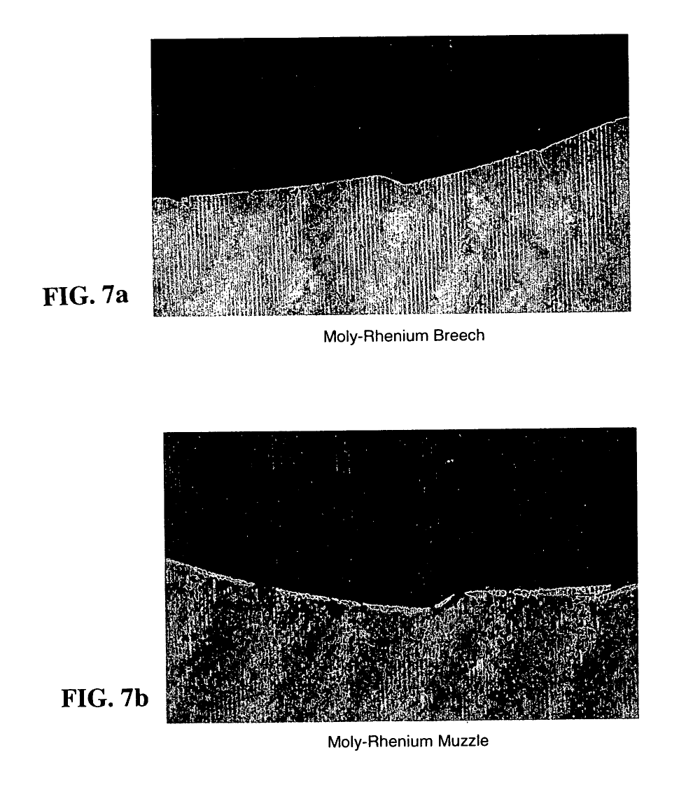

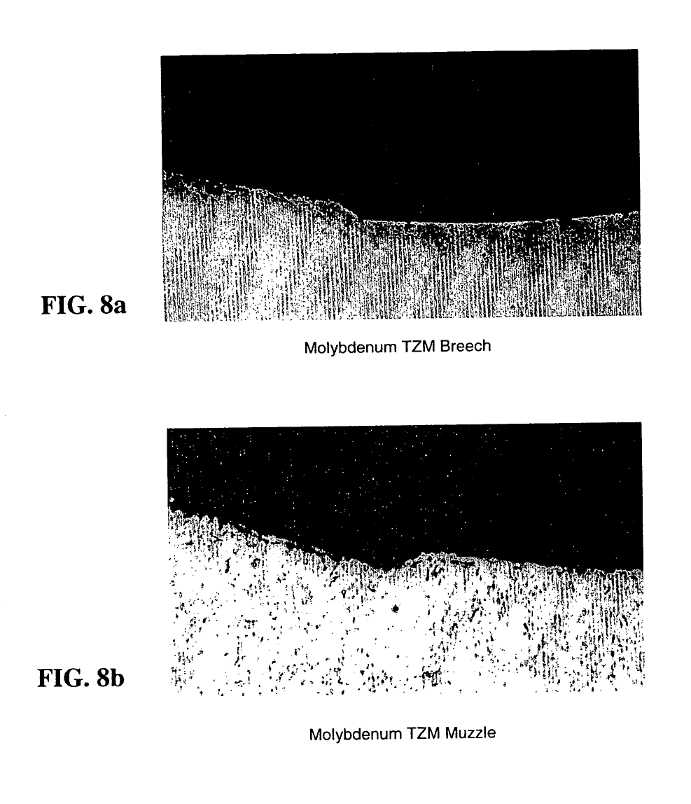

Upon firing, gradual erosion of the coated surface is observed starting at the breech end of the barrel and progressing down the barrel. The average dimensional erosion on the wall of the barrel is about 0.001 inch. The muzzle wear is about 0.0001 inch, indicating excellent wear resistance. FIGS. 6a, 6b, 7a, 7b, 8a and 8b are micrographs showing gun barrel cross sections after the firing tests.

Gun barrels that can benefit from the present invention include all sizes and calibers of gun barrels, including pistols, semi-automatic/automatic weapons, rifles, mortars, gatling gun barrels, chain guns, and large gun barrels such as tank and long range artillery barrels.

While micro-welding of gun barrels is described herein, the present process may be used to coat the inside of other components such as engine cylinders, brake cylinders, bushings and plastic extrusion barrels.

Whereas particular embodiments of this invention have been described above for purposes of illustration, it will be evident to those skilled in the art that numerous variations of the details of the present invention may be made without departing from the invention.

What is claimed is:

1. A method of coating an interior surface of a gun barrel comprising:
micro-welding a protective coating on the interior surface of the gun barrel; and
working the micro-welded coating.

2. The method of claim 1, wherein the protective coating is micro-welded by electro-spark deposition.

3. The method of claim 1, wherein the protective coating is micro-welded on the interior surface of the gun barrel by inserting an electrode comprising the protective coating material into the gun barrel and rotating the gun barrel and the electrode in relation to each other.

4. The method of claim 3, further comprising moving the electrode and the gun barrel in a longitudinal direction in relation to each other.

5. The method of claim 1, wherein the protective coating has a thickness of from about 0.5 to about 2 mil.

6. The method of claim 1, wherein the protective coating has an amorphous or nanocrystalline microstructure with an average grain size of less than 100 nm.

7. The method of claim 1, wherein the protective coating comprises a ceramic.

8. The method of claim 7, wherein the ceramic comprises a carbide, boride or nitride of a transition metal.

9. The method of claim 1, wherein the protective coating comprises a cermet.

10. The method of claim 9, wherein the cermet comprises a carbide of tungsten, tantalum or titanium.

11. The method of claim 1, wherein the protective coating comprises molybdenum.

12. The method of claim 1, wherein the protective coating comprises a lubricating metal.

13. The method of claim 1, wherein the working of the micro-welded coating comprises forging and/or honing.

14. The method of claim 1, wherein the interior surface of the gun barrel is in the form of a smooth cylinder.

15. The method of claim 1, wherein the interior surface of the gun barrel is rifled.

16. The method of claim 15, wherein the interior surface of the gun barrel is rifled after the protective coating is micro-welded on the surface.

17. The method of claim 16, further comprising honing the interior surface of the gun barrel after it is rifled.

18. A gun barrel comprising an interior surface and a micro-welded protective coating on the interior surface.

19. The gun barrel of claim 18, wherein the protective coating has a thickness of from about 0.5 to about 2 mil.

20. The gun barrel of claim 18, wherein the protective coating has an amorphous or nanocrystalline microstructure with an average grain size of less than 100 nm.

21. The gun barrel of claim 18, wherein the protective coating comprises a ceramic.

22. The gun barrel of claim 21, wherein the ceramic comprises a carbide, boride or nitride of a transition metal.

23. The gun barrel of claim 18, wherein the protective coating comprises a cermet.

24. The gun barrel of claim 23, wherein the cermet comprises a carbide of tungsten, tantalum or titanium.

25. The gun barrel of claim 18, wherein the protective coating comprises molybdenum.

26. The gun barrel of claim 18, wherein the protective coating comprises a lubricating metal.

27. The gun barrel of claim 18, wherein the protective coating is forged.

28. The gun barrel of claim 18, wherein the protective coating is honed.

29. The gun barrel of claim 18, wherein the interior surface of the gun barrel is a smooth cylinder.

30. The gun barrel of claim 18, wherein the interior surface of the gun barrel is rifled.

31. The gun barrel of claim 30, wherein the rifled interior surface of the gun barrel is honed.

32. The gun barrel of claim 18, wherein the gun barrel comprises steel.
